(19) United States
(12) Patent Application Publication
(10) Pub. No.: US 2006/0166182 A1
(43) Pub. Date: Jul. 27, 2006

(54) Tissue and organ preservation, protection and resuscitation

(75) Inventors: Guy Weinberg, Chicago, IL (US); William E. Hoffman, Chicago, IL (US); Richard Ripper, Chicago, IL (US); Douglas Feinstein, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: The Board of Trustees of the University of Ilinois a body corporate and politic of the state of Il., Urbana, IL (US)

(21) Appl. No.: 10/541,113

(22) PCT Filed: Dec. 31, 2003
(86) PCT No.: PCT/US03/41605

§ 371 Date: Dec. 22, 2005

Related U.S. Application Data
(60) Provisional application No. 60/437,200, filed on Dec. 31, 2002.

(51) Int. Cl. A01N 1/02

(52) U.S. Cl. 435/1.1

(57) ABSTRACT

The present invention provides compositions and methods for protecting tissues and organs from damage during transplantation or from acute ischemia due to, e.g., injury or surgery. The compositions protect the tissue or organ from acidosis, oxidative damage, ischemia and repurfusion injury while the organ is isolated from the normal circulation or receives inadequate arterial flow.

### RELATED APPLICATION

This application claims priority to U.S. Provisional Application Ser. No. 60/437,200, filed Dec. 31, 2002, which is incorporated herein by reference in its entirety.

### BACKGROUND OF THE INVENTION

Suspended animation has been defined as the therapeutic induction of a state of tolerance to temporary complete systemic ischemia followed by resuscitation to survival without brain damage (Bellamy et al., Suspended animation for delayed resuscitation, Crit. Care Med., 24(2S) Supplement, 24S47S, 1996). Tissue hypoxia begins a cascade of events in the cells of tissues and organs that quickly leads to damage. During prolonged periods of hypoxia, tissue and organ damage is often irreversible.

Hypoxia normally causes cells to develop acidosis due to overproduction of lactic acid. This occurs because inhibition of respiration prevents pyruvate from entering the citric acid cycle. Pyruvate is then converted to lactate which accumulates as long as the block in respiration continues. Lactic acidosis is therefore a major pathologic component of many severe illnesses accompanied by hypoperfusion or other causes of tissue ischemia of vital organs: all forms of shock (septic, hemorrhagic, anaphylactic, cardiogenic), carbon monoxide or cyanide poisoning, respiratory failure from any cause (airway obstruction, pulmonary edema, COPD, ARDS), drowning, asphyxia, high altitude and of course, cardiac arrest. Lactic acidosis also is a major pathologic component of tissue ischemia in specific organs such as the heart (myocardial ischemia/infarction due to coronary occlusion) or brain (arterial insufficiency leading to stroke). It is normally expected that in virtually every setting where tissue hypoxia occurs, it will be accompanied by tissue acidosis and in each of these scenarios, the ability of the organ to recover from the metabolic insult is limited by the degree of tissue acidosis.

Organ preservation and perfusion solutions, along with methods and devices for delivering such solutions, have increased greatly the rate of successful organ transplants and organ surgery. Organs other than hearts can be stored for extended periods prior to transplantation when maintained in a preservation solution. Typically, a heart must be transferred to the recipient host within four hours of harvesting from the donor. During surgery, such as cardiopulmonary bypass surgery, a cardioplegia solution helps preserve the heart during ischemic conditions when the heart is excluded from normal circulation. A variety of organ preservation and cardioplegia solutions are commercially available. Despite these recent advances, damage to organs and tissues due to hypoxic conditions continues to limit the application and effectiveness of transplantation and surgical technologies.

### SUMMARY OF THE INVENTION

The present invention provides compositions and methods for protecting tissues and organs from damage during transplantation or from acute ischemia due to, e.g., injury or surgery. The compositions protect the tissue or organ from acidosis, oxidative damage, ischemia and repurfusion injury while the organ is isolated from the normal circulation or receives inadequate arterial flow.

In certain embodiments, the present invention is directed to a composition for protecting tissue or an organ of a mammal from damage when isolated from the circulatory system, the composition comprising a perfusion solution; and an amount of an amphipathic (having a hydrophilic and lipophilic properties) compound that inhibits metabolism effective to protect the tissue or organ from damage due to tissue anoxia, ischemia, or reperfusion injury. In preferred embodiments, the perfusion solution comprises a preservation solution. In specific embodiments, the preservation solution is selected from the group consisting of Krebs-Henseleit solution, University of Wisconsin solution, St. Thomas II solution, Collins solution, and Stanford solution. However, these are exemplary preservation solutions and those of skill in the art will be aware of other preservation solutions that may be used as perfusion solutions in the compositions of the present invention.

In preferred aspects of the invention, the amount of amphipathic compound that inhibits metabolism is an amount that is effective to prevent accumulation of lactic acidosis. In certain instances, this amount is sufficient to cause cardiac standstill (cardiac asystole) in the mammal. Those of skill in the art will understand that amounts and concentrations of the amphipathic compound can be varied depending on the characteristics of the mammal being treated as long as in the more preferred embodiments the amount is effective to prevent accumulation of lactic acidosis. Exemplary amphipathic compounds that inhibits metabolism are those selected from the group consisting of bupivacaine, levo-bupivacaine, etidocaine, ropivacaine, and tetracaine. Analogs of these anesthetics are known to those skilled in the art and may readily be used as amphipathic compounds in the compositions described herein. In certain embodiments, it is contemplated that the compositions of the invention comprise more than one amphipathic compound, for example, the compositions may comprise a combination of two or more of the anesthetic discussed herein or analogs of such compounds.

In particularly preferred embodiments, the amphipathic compound that inhibits metabolism is bupivacaine. The concentration of the bupivacaine in the compositions of the invention may comprise, between about 50 μM to 2 mM of bupivacaine. It is contemplated that the composition may comprise at least 1 μM, at least 5 μM, at least 10 μM, at least 20 μM, at least 30 μM, at least 40 μM, at least 50 μM, or at least 100 μM, and less than 1 mM, less than 2 mM, less than 3 mM, less than 4 mM, less than 5 mM, or less than 10 mM bupivacaine. It should be understood that any range between these concentrations is expressly contemplated.

The compositions of the present invention may be used to treat any organ that may suffer from tissue damage when isolated from the circulatory system (e.g., damage caused by anoxia). Such damage may result, for example, during surgery when the arterial blood flow is interrupted to the affected tissue or organ. It is particularly contemplated that the compositions of the present invention may be used to protect organs such as brain, heart, lung, kidney, liver, and bowel. In preferred embodiments, the organ is the heart.

Another aspect of the present invention contemplates a method of protecting tissue or an organ of a mammal from damage due to tissue anoxia, ischemia, or reperfusion injury, the method comprises contacting the tissue or organ with an effective amount of the tissue protective composition of the present invention. In specific embodiments, the method is one in which the tissue or organ is contacted with the protective composition prior to removal from the mammal, and/or after organ removal from the mammal and/or during removal of the organ from the mammal.

Any mammal may be contacted with the tissue protective compositions of the present invention as the compositions may be used in human and in veterinary medicine. In specific embodiments, the mammal may be a human, a pig, or a baboon. In particularly preferred embodiments, the mammal is human.

The methods of tissue/organ protection described herein may further comprise the step of contacting the tissue or organ with an amount of a lipid emulsion effective to reverse the effect of the amphipathic compound that inhibits metabolism on the tissue or organ. Typically, the tissue or organ may be contacted with the lipid emulsion prior to transplantation into a host. Other embodiments contemplated contacting the tissue or organ with the lipid emulsion after transplantation into a host. Of course, the tissue or organ may be contacted with the lipid emulsion during the transplantation procedure as well as before, during and after the transplantation into a host.

Yet a further aspect of the present invention contemplates a method of protecting tissue or an organ of a mammal from damage due to tissue anoxia, ischemia, or reperfusion injury, the method comprising administering to the mammal an effective amount of the tissue-protective compositions described herein. The composition may be administered systemically. Alternatively, the composition is administered directly to the tissue or organ. The composition also may be administered systemically and locally. It is contemplated that the tissue protective methods of the invention will be particularly useful where the tissue anoxia, ischemia, or reperfusion injury is due to isolation of the tissue or organ from the circulatory system. In other embodiments, the tissue protective methods of the invention are used to combat tissue anoxia, ischemia, or reperfusion injury due to acute ischemia. In certain embodiments, the acute ischemia is ischemia that is caused during a transplant or surgery wherein the arterial blood supply is interrupted. In exemplary embodiments, the surgery is a cardiopulmonary bypass surgery. In certain aspects of the invention, the methods for tissue/organ protection further comprise the step of administering an amount of a lipid emulsion effective to reverse the effect of the amhilic agent (e.g., lipophilic local anesthetic) on the tissue or organ. In particular embodiments the mammal subjected to the protective treatment methods of the invention is human.

In specific embodiments, the present invention describes a method of protecting tissue or an organ from damage due to hypoxia, wherein the method comprises contacting the tissue or organ with an amount of amphilic agent (e.g., lipophilic local anesthetic) effective to protect from damage due to hypoxia; and administering an amount of a lipid emulsion effective to reverse the effect of bupivacaine on the organ.

Other aspects of the present invention contemplated kits that comprise a composition for protecting tissue or an organ of a mammal from damage when isolated from the circulatory system, the composition comprising a perfusion solution; and an amount of an amphipathic compound that inhibits metabolism effective to protect the tissue or organ from damage due to tissue anoxia, ischemia, or reperfusion injury wherein the composition is provided in one or more containers. In preferred embodiments, the kits comprise a first container comprising a perfusion solution and a second container comprising an amphipathic compound. The kits may further comprise a further container comprising a lipid emulsion. The kits of the invention also may comprise a device to administer one or more of the components of the composition or the lipid emulsion to a mammal. In specific embodiments, the device is a syringe, catheter, or tubing. It is contemplated that the syringe or cassette may be preloaded with one or more of the components of the tissue-protective compositions described herein.

Other features and advantages of the methods and compositions of the invention will become apparent from the following detailed description. It should be understood, however, that the detailed description and the specific examples, while indicating preferred embodiments of the invention, are given by way of illustration only, because various changes and modifications within the spirit and scope of the invention will become apparent to those skilled in the art from this detailed description.

### BRIEF DESCRIPTION OF THE DRAWING

FIG. 1. Changes in myocardial tissue pH (pHm), carbon dioxide pressure (PmCO₂), and oxygen pressure (PmO₂).

FIG. 2. Left-ventricular pressure after 24 hours Langendorf preparation without (top) and with 500 μM bupivacaine.

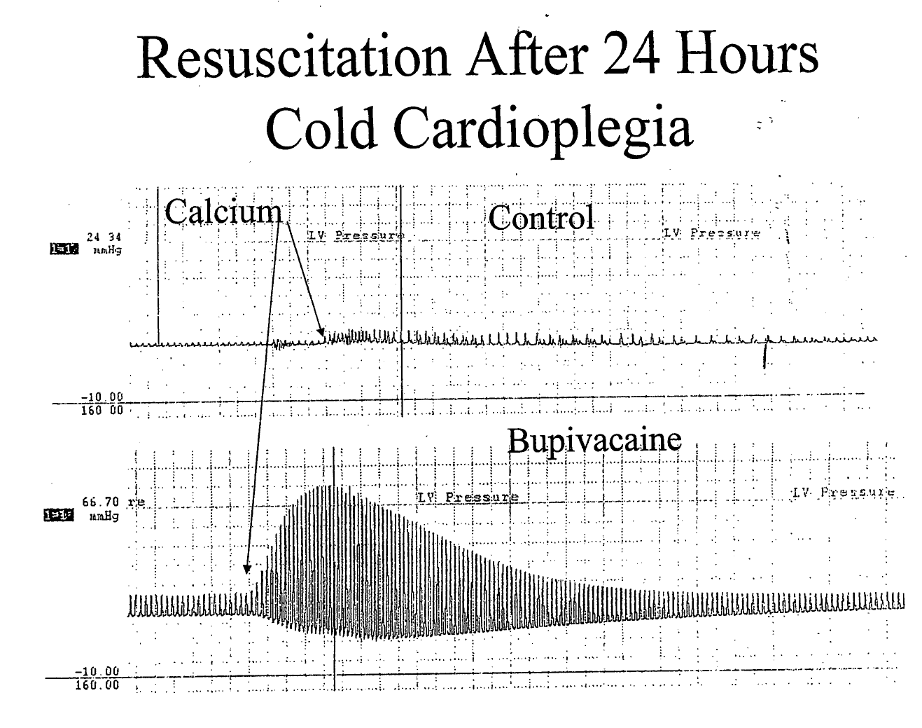

### BRIEF DESCRIPTION OF PREFERRED EMBODIMENTS OF THE INVENTION

The present invention relates to the use of certain reversible metabolic inhibitors to protect tissues and organs from the effects of acidosis, oxidative damage, ischemia and repurfusion injury while the organ is removed from the normal body circulation. By reversible, it is meant that the metabolic inhibitory activity of the compound or composition on the tissue or organ can be inhibited or removed by contacting the tissue or organ with a second compound or composition. Preferred reversible metabolic inhibitors are amphipathic compounds, which are reversible by removal or inactivation by a lipid emulsion. In certain embodiments the amphipathic metabolic inhibitor is a local anesthetic. Preferred local anesthetics possess an aliphatic side chain making the anesthetic lipophilic and able to penetrate the cell membrane. Exemplary anesthetics include, but are not limited to, bupivacaine, levo-bupivacaine, etidocaine, ropivacaine, and tetracaine.

Organs treated with an effective amount these reversible metabolic inhibitors can withstand severe hypoxia, e.g. because of impaired arterial perfusion, without developing the expected tissue acidosis. After a period of time, the metabolic and other effects of the local anesthetic on the tissue or organ can be reversed, e.g., by administration of a lipid infusion. Preferred lipid infusions are suitable for injection and comprise lipid droplets of such size that they can cross the capillary bed without restricting blood flow. Examples include emulsions of soybean oil or other sources of triglycerides. One such emulsion is commercially available as INTRALIPID.

Tissue- and Organ-Protecting Compositions

In certain aspects, the invention provides compositions for protecting a tissue or organ from damage when such tissue or organ is isolated from the circulatory system. Exemplary tissue- and organ-protecting compositions of the present invention comprise a perfusion solution and an amount of a reversible metabolic inhibitor effective to protect a tissue or organ from damage due to hypoxia or acidosis. The perfusion solution can be a cardioplegia solution used to perfuse the heart while it is stopped. The perfusion solution also can be an organ preservation solution used to protect an isolated organ from damage during storage, ischemia, or reperfusion.

Preferred perfusion solutions are preservation solutions, such as cardioplegia solutions for the heart, and include, but are not limited to, Krebs-Henseleit solution, University of Wisconsin solution, St. Thomas II solution, Buckberg solution, CELSIOR® solution, Collins solution, and Stanford solution. See, e.g., U.S. Pat. Nos. 4,798,824 and 4,938,961, incorporated herein by reference in their entirety. Generally, perfusion solutions are buffered solutions comprising salts, such as calcium chloride, potassium chloride, or magnesium chloride, and substrates such as glutamate or aspartate. Cardioplegia solutions tend to contain high potassium, magnesium, crystalloid solution, and substrates and then is mixed with blood. The high potassium content of the solution electrically quiets the heart. Because certain reversible metabolic inhibitors, e.g., bupivacaine, quiet the heart, the reversible metabolic inhibitor can substitute for a portion or all of the potassium in a cardioplegia solution.

Tissue- or organ-protecting compositions of the present invention can comprise a lipophilic local anesthetic. Preferred lipophilic local anesthetics include, but are not limited to, bupivacaine, levo-bupibacaine, etidocaine, ropivacaine, and tetracaine. The amount of the anesthetic in the composition is effective to protect a tissue or organ from damage due to acidosis, oxidative damage, ischemia and repurfusion injury during the absence of adequate arterial blood flow. In certain embodiments, the amount of the anesthetic in the composition is effective to cause asystole when administered directly or indirectly to the heart of a mammal. As will be understood by those of skill in the art, the effective amount may differ depending on the desired tissue or organ to protect (e.g., brain, heart, lung, kidney, liver, skeletal muscle, or bowel), the method of administering or contacting the tissue or organ with the anesthetic, or the size of the organ. In preferred embodiments, the concentration of the reversible metabolic inhibitor, e.g., bupivacaine, is at least 1 μM, at least 5 μM, at least 10 μM, at least 20 μM, at least 30 μM, at least 40 μM, at least 50 μM, or at least 100 μM, and less than 1 mM, less than 2 mM, less than 3 mM, less than 4 mM, less than 5 mM, or less than 10 mM. In certain embodiments, the composition comprises about 500 μM bupivacaine.

In preferred embodiments, the amount of reversible metabolic inhibitor is effective to protect the tissue or organ from the effects of at least 8 hours of storage outside of circulation. For the heart, an amount of reversible metabolic inhibitor is effective to protect the tissue or organ from the effects of at least 8 hours of storage outside of the circulation. For other organs, longer periods are contemplated such as 12, 18, 24, or 36 hours. Generally, such amounts are effective to protect the tissue or organ at least 10%, at least 20%, at least 30%, at least 40%, at least 50%, at least 60%, at least 70%, at least 80%, at least 90%, at least 100%, at least 200%, at least 300%, at least 400%, at least 500%, at least 600%, at least 700%, at least 800%, at least 900%, or at least 1000% greater than the perfusion solution alone.

Tissue- or organ-protecting compositions of the present invention can further comprise additional compounds useful in protecting an organ from the effects of hypoxia. Such compounds include Coenzyme Q₁₀, peptide fragments, indenoindole compounds, thiazolidinedione compounds such as pioglipazone, and fructose-1-6-diphosphate See, e.g., U.S. Pat. Nos. 5,719,174; 6,054,261; and 6,645,938.

Further provided are methods of making a composition of the present invention. In a preferred embodiment, the reversible metabolic inhibitor is added to or admixed with a perfusion solution. In an alternative embodiment, the reversible metabolic inhibitor is added or admixed with one or more components of a perfusion solution then one or more of the additional components of the perfusion solution are added or admixed.

Tissue- and Organ-Protecting Methods

Metabolic inhibitors can preserve function in organs deprived of oxygen for extended periods of time. The present invention provides methods wherein the metabolic inhibition is reversed allowing the tissue of organ to regain proper metabolic activity and function. The methods of the present invention have a wide range of possible medical applications: preservation of organs intended for transplant, preservation of organs from hemorrhagic shock, or as cardioplegia to protect the heart, or other organs, during surgery. The methods can be applied to preserve organ function prior to definitive surgical intervention for out-of-hospital injuries or even cardiac arrest. In a preferred embodiment, the invention provides a method wherein a reversible metabolic inhibitor is used in a combat casualty dying of exsanguinating hemorrhage. In one such method, bupivacaine administered by intravenous injection in the field induces metabolic “suspended animation” thereby allowing time for transport to a hospital, where medical and surgical treatment can repair wounds prior to reversal of bupivacaine with lipid infusion.

In one aspect, the present invention provides a method of preserving tissues or organs for transplantation. In preferred embodiments, donor heart, lung, kidney, bowel or liver is sustained prior to transplantation for extended periods of time by perfusing the donor or the organ with a reversible metabolic inhibitor and, optionally, adding other standard methods for organ preservation. This method significantly prolongs the acceptable lag time before transplant surgery must be performed, allowing more time for tissue typing, recipient selection, and surgical preparation. In a preferred embodiment, preserved tissues or organs can be stored in a “bank,” similar to blood banks.

In another aspect, the present invention provides a method of protecting a tissue or organ during surgery. In known methods of protecting the heart during surgery, the heart is typically cooled and perfused with cardioplegia solution during cardiopulmonary bypass. This slows metabolic activity and thereby prolongs the time ischemia will be tolerated. A method of the present invention allows more effective reduction in cardiac metabolism with little or no tissue hypothermia. Thus protection is longer, and avoids the adverse effects of deep hypothermia. This approach can also be used as a means of circulatory arrest for complex neurosurgical procedures where circulatory arrest with extreme hypothermia is now used to provide surgical exposure and avoid bleeding, for instance in very large cerebral aneurysms. Bupivacaine infusion provides a reversible means of circulatory, and metabolic, arrest with only minimal hypothermia.

In a further aspect of the invention, the present invention provides a method of delayed resuscitation. In an exemplary embodiment, a combat casualty is placed in “suspended animation” by on-site injection of bupivacaine, then evacuated to a hospital for surgical repair, treatment and resuscitation before lipid rescue from the bupivacaine. In another embodiment, a patient suffering out-of-hospital cardiac arrest, unresponsive to rapid defibrillation receives bupivacaine administered on-site by EMTs as the second line therapy, thereby allowing transfer to a hospital for definitive diagnosis and treatment.

In yet another aspect of the invention, the present invention provides organ protection during acute ischemia, which includes anticipated ischemia due to clamping of an artery, e.g., aorta or carotid artery, during surgery. Acute ischemia of brain, kidney, bowel, or heart is a major cause of morbidity and mortality. Current interventions recognize there is a window of opportunity to intervene, surgically or medically, to prevent irreversible damage to these vital organs. Systemic or selective bupivacaine infusion is administered as a means to prolong this window by interrupting metabolism, and thereby allowing time for treatment of underlying vascular abnormalities before infarction of tissue occurs. The methods of the present invention further provide protection from generalized lactic acidosis due to skeletal muscle ischemia.

In preferred embodiments, a reversible metabolic inhibitor is administered systemically with a syringe by simple intravenous injection or by direct injection into an artery, such as the aorta, in a patient undergoing surgery or an isolated organ. In a patient in cardiac arrest, chest compressions (BLS) may also be needed to circulate the drug to target organs. Alternatively, the reversible metabolic inhibitor can be administered directly into the tissue or organ to be protected. Administration of a reversible metabolic inhibitor can be by syringe, catheter, pump, or bathing or submersing an organ in a composition comprising the reversible metabolic inhibitor.

In important aspect of the present invention is the ability to reverse the metabolic inhibitory effects of the compounds or compositions, thereby restoring function to the tissue or organ. Methods using bupivacaine or other local anesthetics for organ preservation preferably include reversal of anesthetic effects by infusion of lipid emulsion. In preferred embodiments, the emulsion is administered based on the weight of the individual or organ, type of organ, or the amount of reversible metabolic inhibitor administered. The lipid emulsion is preferably administered as a bolus injection followed be continuous administration of the emulsion until the metabolic effects are reversed. Reversal of metabolic effects can be determined by a number of methods and often will depend on the tissue or organ to be monitored. For example, reversal of the metabolic effect on the heart can be determined by EKG or on the brain by EEG.

Medical Devices

The metabolic inhibitor- and reversing-compounds or compositions of the present invention can be used in perfusion devices. A perfusion device as used herein is any mechanical device that be used to infuse a specific organ or the systemic circulation with a solution comprising the compound or composition. Such a device can contain one or more reservoirs. In a preferred embodiment, the device comprises a reservoir for the reversible metabolic inhibitor and a reservoir for the reversing compound or composition. For example, the device can contain a reservoir for bupivacaine and a reservoir for a lipid emulsion. The device can include a tube, catheter, or cannula leading from the reservoir that can be inserted into an organ, vein or artery. The device can be an electromechanical device having electric pumps and devices for controlling the temperature, rate or volume of delivery of the solution. In certain embodiments, the device is programmable so that the one or more solutions are delivered in an appropriate temperature, rate or volume for a particular clinical situation, weight of the organ, or size of the organ (e.g., cardiopulmonary bypass surgery vs. kidney transplant vs. liver transplant). Exemplary devices include those commercially available by BARD Inc., and those described in U.S. Pat. Nos. 5,011,469 and 6,221,063, both of which are incorporated herein by reference.

Kits

The present invention further provides kits containing a local anesthetic and a lipid emulsion for reversing the effect of the local anesthetic. Such kits may include further include one or more medical devices as indicated above such as a syringe, pump or catheter and may be customized to a particular tissue or organ. The kit may further include instructions for performing a method of the present invention.

### EXAMPLE

This example describes a method of protecting the heart during ventricular fibrillation by the administration of the local anesthetic, bupivacaine. Bupivacaine significantly reduced the rate of decrease in pH during fibrillation by a factor of four. The toxic effect of the bupivacaine on the heart was reversed by administration of a lipid emulsion.

Dogs made hypotensive by treatment with bupivacaine, do not develop the expected acidosis in myocardial tissue, despite prolonged periods of severe systemic hypotension (BP<40 mmHg), hypoperfusion and extreme cardiac tissue hypoxia (pO2 undetectable with intramyocardial probe). Bupivacaine cardiotoxicity can be reversed, preferably by administering an intravenous lipid emulsion. Although the invention is not intended to be limited by the mechanism, the lipid emulsion probably draws, or ‘extracts’ the highly lipophilic bupivacaine molecules from vital organs into the lipemic phase created by the lipid infusion. This leads to recovery of normal cardiac function as coronary blood flow and tissue pO2 return to normal values. Furthermore, brain function as determined by EEG, returns to normal values following the identical periods of extremely low, or no, cerebral blood flow. Thus, an animal can sustain a prolonged episode of myocardial anoxia and cerebral hypoperfusion yet still recover normal cardiac function and EEG. So bupivacaine, while traditionally viewed as a toxin, can actually prevent irreversible tissue damage from extreme hypoxia, by blocking the attendant tissue acidosis and possibly other mechanisms.

Material and Methods

Non-purpose bred male hounds (22-26 kg) were used. Dogs were fasted overnight. On the day of the example, the dog was anesthetized with 5 mg/kg propofol, intubated and ventilated with 1.5% isoflurane and inspired oxygen concentration of 30%. Catheters were inserted into the femoral artery for blood pressure recording and blood gas sampling, and the femoral vein for fluid and drug administration. Sterile saline was infused intravenously (4 ml·kg⁻¹·hr⁻¹) for fluid maintenance.

An incision was made along the left 5th intercostal space and the left ventricle exposed. A Paratrend tissue probe (Codman Inc, Newark, N.J.) was calibrated on the day of the study using precision gases. The probe was 0.5 mm in diameter and 2 sensors measuring myocardial tissue oxygen pressure (PmO₂) and myocardial pH (pHm) were contained in the final 2 cm. The void surrounding the pHm sensor was filled with acrylamide gel containing phenol red. Changes in hydrogen ion concentration produce color changes in phenol red, which can be detected by the pH fiber optic sensor. A fluorescence method was used to measure the partial pressure of dissolved or gaseous oxygen for the fiber optic PmO₂ sensor. The 0%-90% response times for the PmO₂ and pHm sensors were 78 s and 70 s, respectively. The probe was inserted into the myocardium in the region between the first and second diagonal branch of the left anterior descending coronary artery, parallel to the surface of the heart 6 mm below the surface using an 18 gauge angiocatheter as an introducer. Mechanical ventilation was adjusted to maintain arterial pCO2 at 35±2 mmHg and inspired oxygen concentration was maintained at 30%, with the balance nitrogen. Body temperature was maintained at 38° C. using a warming pad.

After equilibration of the myocardial tissue probe for 45 minutes, baseline measures of mean arterial pressure (MAP), heart rate, pmO2 and pHm were recorded and an arterial blood gas sample was measured. Each dog received an intravenous infusion of 10 mg/kg bupivacaine over 10 seconds. The time was noted at the onset of criteria for circulatory arrest (HR<10 and mean blood pressure below 30 mmHg), at which time internal cardiac massage was instituted, isoflurane was discontinued and ventilation maintained with 100% oxygen. In a preliminary study (early lipid, EL), intervention at the onset of circulatory collapse included an intravenous infusion of either soy lipid emulsion (Intralipid 20%, Fresenius Kabi Clayton, Clayton, N.C.) n=3, or saline, n=3, each administered as a 4 ml/kg bolus (over 2 minutes), followed by a continuous infusion of 0.5 ml·kg⁻¹·min⁻¹ for 10 minutes. The protocol was subsequently modified to better simulate a clinical setting, where the start of the infusion might be delayed by several minutes. In this protocol (delayed lipid, DL), internal cardiac massage alone was continued for 10 minutes, then infusion of either the lipid emulsion (n=6) or saline (n=6) was begun as described above. If sinus rhythm returned, internal cardiac massage was continued until MAP reached 30 mmHg and recovery measures of pmO2 and pHm were recorded when blood pressure returned to within 10% of baseline levels. Dogs were killed at the end of the study using a euthanasia solution. The investigators were not blinded to treatment arm.

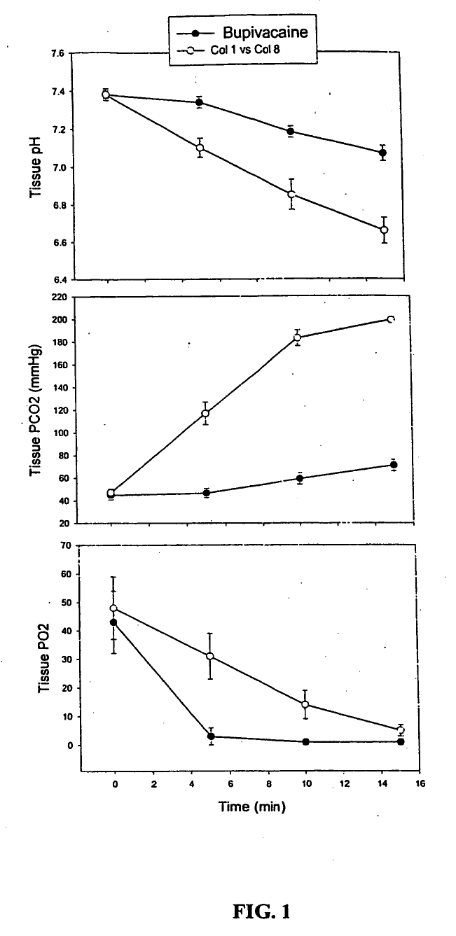

The results are shown in the Tables and FIG. 1. Data are reported for the DL experiments as mean±SD. pmO2 and pHm were compared between baseline and subsequent treatments within each group using repeated measures analysis of variance with Tukey's tests for post-hoc comparisons. Differences between groups for each treatment were compared by Student's t-test. The proportion of animals surviving bupivacaine challenge in each group was compared in the DL experiment using a z-test. Significance was taken as p<0.05.

Arterial blood pressure, heart rate and arterial blood gases under baseline anesthetized conditions are shown in Table 1. There were no significant differences between groups. Table 2 shows PmO2 and pHm under baseline conditions and ventricular fibrillation. The decrease in PmO2 occurred at a higher rate in bupivacaine treated compared to sham treated dogs, but this difference was not significant. Tissue pH decreased a similar amount in half the time in sham treated dogs, and the rate of pH decrease was greater in these dogs compared to bupivacaine treated dogs. All dogs were resuscitated using lipid emulsion when pHm decreased to 7.0 or after 20 min, whichever occurred first.

In four dogs per group, PmO2 and pHm were allowed to decrease for 15 minutes of cardiac fibrillation at the end of the study. The decrease in PmO2 and pHm and the increase in PmCO2 are shown in FIG. 1. The rate of decrease in pHm and increase in PmCO2 was faster in sham treated dogs, but the rate of decrease in PmO2 was slower compared to bupivacaine treated dogs during fibrillation.

TABLE 1
Mean arterial pressure (MAP), heart rate (HR), arterial oxygen pressure
(PaO2), arterial CO2 pressure (PaCO2), arterial pH (pHa) under baseline
conditions in sham and bupivacaine treated dogs.

| Treatment | n | MAP (mmHg) | HR (min − 1) | PaO2 (mmHg) | PaCO2 (mmHg) | pHa |
|---|---|---|---|---|---|---|
| Sham | 7 | 88 ± 16 | 136 ± 22 | 261 ± 29 | 34 ± 3 | 7.39 ± 0.03 |
| Bupivacaine | 5 | 83 ± 3 | 126 ± 7 | 242 ± 45 | 36 ± 2 | 7.38 ± 0.05 |

Mean ± SD

TABLE 2
Baseline myocardial tissue oxygen pressure (PmO2) and pH, decrease and rate of
decrease during cardiac fibrillation in bupivacaine and sham treated dogs.

| | Base | PmO2 | | Rate of | | | | Rate of |
|---|---|---|---|---|---|---|---|---|
| | PmO2 | decrease | Time | decrease | Base | PH | Time | Decrease |
| Treatment | (mmHg) | (mmHg) | (min) | (mmHg/min) | pH | decrease | (min) | (min − 1) |
| Sham | 49 ± 11 | 41 ± 11 | 3.0 ± 1.5 | 16 ± 5 | 7.32 ± 0.02 | 0.42 ± 0.13 | 6.2 ± 3.3 | 0.08 ± 0.02 |
| Bupivacaine | 52 ± 17 | 52 ± 16 | 2.5 ± 0.9 | 22 ± 5 | 7.28 ± 0.10 | 0.31 ± 0.08 | 13.8 ± 5.1* | 0.02 ± 0.01* |

Mean ± SD, *= P < 0.05 compared to sham

1. A composition for protecting tissue or an organ of a mammal from damage when isolated from the circulatory system, comprising:
(a) a perfusion solution; and
(b) an amount of an amphipathic compound that inhibits metabolism effective to protect the tissue or organ from damage due to tissue anoxia, ischemia, or reperfusion injury.

2. The composition of claim 1, wherein the perfusion solution comprises a preservation solution.

3. The composition of claim 2, wherein the preservation solution is selected from the group consisting of Krebs-Henseleit solution, University of Wisconsin solution, St. Thomas II solution, Collins solution, and Stanford solution.

4. The composition of claim 1, wherein the amount of an amphipathic compound that inhibits metabolism is effective to prevent lactic acidosis.

5. The composition of claim 1, wherein the amphipathic compound that inhibits metabolism is selected from the group consisting of bupivacaine, levo-bupivacaine, etidocaine, ropivacaine, and tetracaine.

6. The composition of claim 5, wherein the amphipathic compound that inhibits metabolism is bupivacaine.

7. The composition of claim 6, wherein the composition comprises 50 μM to 2 mM of bupivacaine.

8. The composition of claim 1, wherein the organ is selected from the group consisting of brain, heart, lung, kidney, liver, skeletal muscle, and bowel.

9. The composition of claim 8, wherein the organ is the heart.

10. A method of protecting tissue or an organ of a mammal from damage due to tissue anoxia, ischemia, or reperfusion injury, the method comprising contacting the tissue or organ with an effective amount of the composition of claim 1.

11. The method of claim 10, wherein the tissue or organ is contacted prior to, during, or after removal from the mammal.

12. (canceled)

13. The method of claim 10, wherein the mammal is selected from the group consisting of human, pig, and baboon.

14. (canceled)

15. The method of claim 10, further comprising the step of contacting the tissue or organ with an amount of a lipid emulsion effective to reverse the effect of the amphipathic compound that inhibits metabolism on the tissue or organ.

16. The method of claim 15, wherein the tissue or organ is contacted with the lipid emulsion prior to, during or after transplantation into a host.

17. (canceled)

18. A method of protecting tissue or an organ of a mammal from damage due to tissue anoxia, ischemia, or reperfusion injury, the method comprising administering an effective amount of the composition of claim 1 to the mammal.

19. The method of claim 18, wherein the composition is administered systemically.

20. The method of claim 18, wherein the composition is administered directly to the tissue or organ.

21. The method of any claim 18, wherein the tissue anoxia, ischemia, or reperfusion injury is due to isolation of the tissue or organ from the circulatory system.

22. The method of claim 21, wherein the tissue anoxia, ischemia, or reperfusion injury is due to interruption of the arterial blood supply occurs during a transplant or other surgery.

23. The method of claim 22, wherein the surgery is a cardiopulmonary bypass surgery.

24. The method of claim 18, wherein the mammal is human.

25. The method of claim 18, further comprising the step of administering an amount of a lipid emulsion effective to reverse the effect of the amphipathic compound on the tissue or organ.

26. A method of protecting tissue or an organ from damage due to tissue hypoxia, the method comprising:
(a) contacting the tissue or organ with an amount of an amphipathic metabolic inhibitor effective to prevent lactic acidosis; and
(b) administering an amount of a lipid emulsion effective to reverse the effect of the amphipathic metabolic inhibitor on the organ.

27. A kit comprising the composition of claim 1 in one or more containers.

28. The kit of claim 27, further comprising a lipid emulsion in one or more containers.

29. The kit of claim 27, further comprising a device to administer the composition or the lipid emulsion to a mammal.

30. The kit of claim 29, wherein the device is selected from the group consisting of a catheter, a syringe, or a cannula.

31. The kit of claim 27, further comprising a programmable device for administering the one or more compositions of the kit.
